(19) United States
(12) Patent Application Publication
(10) Pub. No.: US 2015/0212046 A1
(43) Pub. Date: Jul. 30, 2015

(54) Soundwave-Based Cup Bottom Detection Test System

(71) Applicant: Power Source and Associates Corp., Taipei (TW)

(72) Inventors: Tzu-Chi LIN, Taipei (TW); Hsien-Jen LIN, Taipei (TW)

(73) Assignee: Power Source and Associates Corp., Taipei (TW)

(21) Appl. No.: 14/218,694

(22) Filed: Mar. 18, 2014

(30) Foreign Application Priority Data
Jan. 27, 2014 (TW) 103102986

(51) Int. Cl. G01N 29/04; G01N 29/44

(52) U.S. Cl. CPC G01N 29/04; G01N 29/4436; G01N 2291/023; G01N 2291/0289

(57) ABSTRACT

Provided is a soundwave-based cup bottom detection test system which includes a feeding module, a vacuum ball, a conveying module, a voiceprint test module, a rejection module and a collection module. The soundwave-based cup bottom detection test system tests a cup bottom of a cup under test by means of sound waves and determines whether the cup under test is good. The soundwave-based cup bottom detection test system performs an effective test on the cup bottoms of the cups under test quickly by means of voiceprint testing to reject bad cups and collect good cups, thereby ensuring the high quality of the cups thus manufactured and enhancing the cup manufacturing efficiency.

### BACKGROUND OF THE INVENTION

1. Technical Field

The present invention relates to cup bottom test systems, and more particularly, to a soundwave-based cup bottom detection test system with a voiceprint test module.

2. Description of Related Art

Paper cups, together with disposable cups, are heavily used and have a wide variety of applications in modern societies with busy lifestyles and top priority given to efficiency. Paper cups, from ones made of paper by a simple manufacturing process to delicate ones for holding hot soups, coffee, or noodle, are in wide use at any time and any place.

However, there are good as well as bad cups in terms of quality. When using cups to hold hot drinks or hot soups, users often get burnt because the bottoms of the cups are defectively manufactured. Defectively manufactured bottoms of cups will bring inconvenience to users, even in case of a spill of cold drinks instead of hot drinks contained in the cups.

Accordingly, it is important for cup manufacturers to provide an innovative test method for selecting and rejecting cups with bad cup bottoms in a simple and precise manner before delivery of cups, so as to effectively avoid the inconvenience and even injuries otherwise caused to users by the bad cup bottoms.

### BRIEF SUMMARY OF THE INVENTION

The present invention relates to a soundwave-based cup bottom detection test system for performing an effective test on a cup bottom of a cup under test quickly by means of voiceprint testing, thereby ensuring the high quality of the cups thus manufactured.

The present invention provides a soundwave-based cup bottom detection test system, comprising: a feeding module for feeding consecutively at least a cup under test each having a cup mouth and a cup bottom; a vacuum ball disposed rotatably at an outlet of the feeding module to suck the cup mouth and drive the cup under test rotationally; a conveying module fixed to the vacuum ball from below and having a conveyor belt for conveying the cup under test having just fallen off the vacuum ball with the cup mouth facing upward, wherein the conveying module has a test area, a rejection area and a collection area arranged in sequence; a voiceprint test module fixed to the conveyor belt in the test area from above and adapted to emit sound waves toward the cup bottom, receive returning wave reflected off the cup bottom, produce a test voiceprint, and determine whether the cup under test is a good cup or a bad cup; a rejection module fixed laterally to the conveyor belt in the rejection area and adapted to reject the bad cup; and a collection module disposed fixedly in the collection area and adapted to collect the good cup.

Implementation of the present invention at least involves the following inventive steps:

1. ensure that cup bottoms can be manufactured and installed quickly, easily, and cheaply;

2. ensure that every cup delivered will have a good cup bottom; and

3. ensure that every cup delivered will be safe to use and will not cause inconvenience or injuries to users because of its cup bottom gets damaged.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1A is a schematic perspective view of a soundwave-based cup bottom detection test system according to an embodiment of the present invention;

FIG. 1B is another schematic perspective view of the soundwave-based cup bottom detection test system according to the embodiment of the present invention;

FIG. 2 is yet another schematic perspective view of the soundwave-based cup bottom detection test system according to the embodiment of the present invention; and

FIG. 3 is a block diagram of a soundwave-based cup bottom detection test system according to the embodiment of the present invention.

FIG. 4 is a block diagram of another soundwave-based cup bottom detection test system according to the embodiment of the present invention.

### DETAILED DESCRIPTION OF THE INVENTION

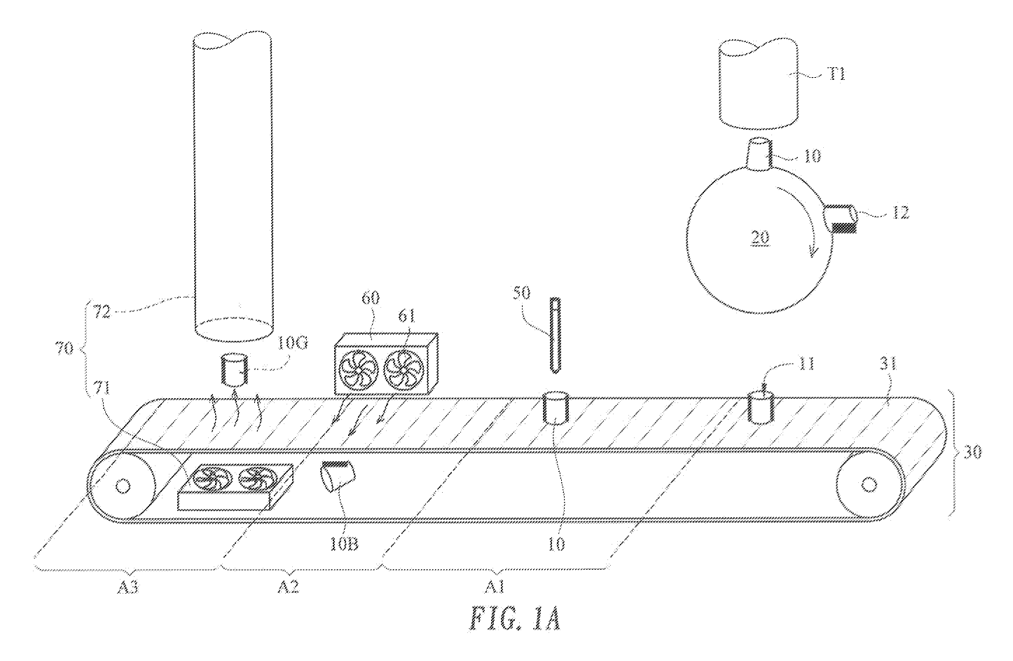

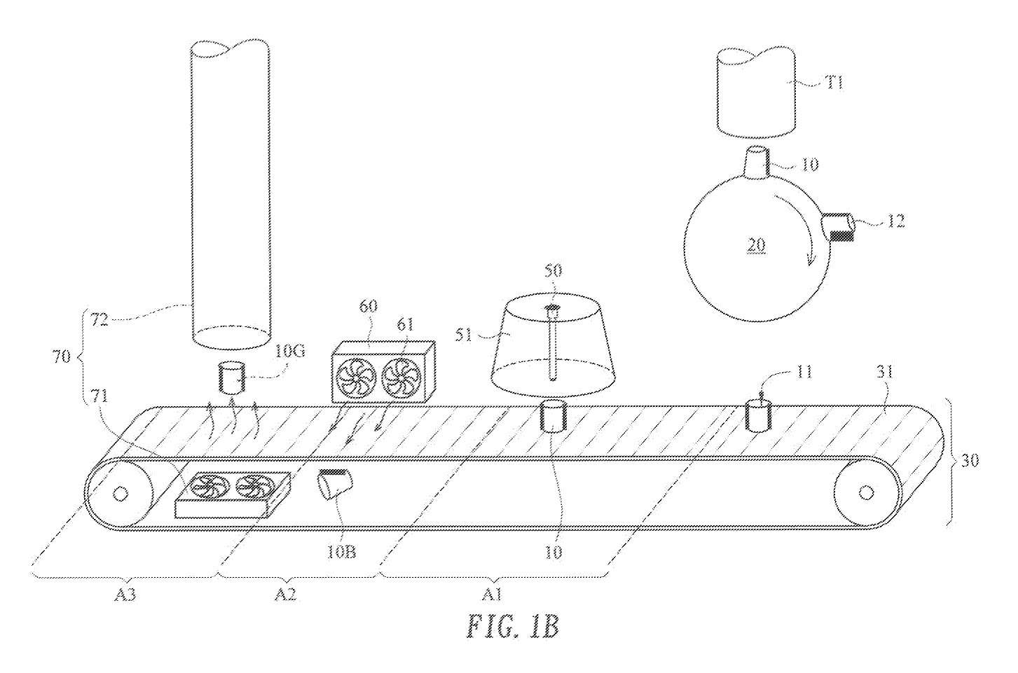

Referring to FIG. 1A, in an embodiment of the present invention, a soundwave-based cup bottom detection test system 100 comprises a feeding module T1, a vacuum ball 20, a conveying module 30, a voiceprint test module 50, a rejection module 60, and a collection module 70.

Referring to FIG. 1A, the feeding module T1 feeds through an outlet thereof at least a cup under test 10 consecutively. The at least a cup under test 10 has a cup mouth 11 and a cup bottom 12. During the paper cup manufacturing and testing process, a feeding tube functions as the feeding module T1, and the at least a cup under test 10 is fed consecutively through the outlet of the feeding tube.

Referring to FIG. 1A, the vacuum ball 20 is disposed rotatably at the outlet of the feeding module T1. The vacuum ball 20 sucks the cup mouth 11 of the at least a cup under test 10 fed by the feeding module T1 and drives the at least a cup under test 10 rotationally.

Referring to FIG. 1A, the conveying module 30 is fixed to the vacuum ball 20 from below. The conveying module 30 has a conveyor belt 31 for conveying the at least a cup under test 10 having just fallen off the vacuum ball 20 with the cup mouth 11 facing upward. The conveying module 30 has a test area A1, a rejection area A2 and a collection area A3 which are arranged in sequence.

Referring to FIG. 1A, the voiceprint test module 50 is fixed to the conveyor belt 31 in the test area Al from above and adapted to emit sound waves toward the cup bottom 12, receive the returning waves (reflected waves) reflected off the cup bottom 12, produce a test voiceprint, and determine whether the at least a cup under test 10 is a good cup 10G or a bad cup 10B in accordance with the test voiceprint.

To determine whether the at least a cup under test 10 is a good cup 10G or a bad cup 10B, the voiceprint test module 50 compares the test voiceprint and a pre-stored good voiceprint or bad voiceprint and determines whether each said cup under test 10 is a good cup 10G with a good said cup bottom 12 or a bad cup 10B with a bad said cup bottom 12 in accordance with a result of the comparison.

In an embodiment of the present invention, the good voiceprint for use as a comparison-related reference is produced by detecting the cup bottoms 12 of multiple good cups 10G with the voiceprint test module 50, producing a test voiceprint, and storing the test voiceprint for use as a comparison-related reference. In practice, the voiceprint test module 50 detects the cup bottoms 12 of 10 good cups 10G and produces a good voiceprint in accordance with the test voiceprint of the cup bottoms 12 of the 10 good cups 10G.

Furthermore, a bad voiceprint for use as a comparison-related reference is produced by detecting the cup bottoms 12 of multiple bad cups 10B with the voiceprint test module 50, producing a test voiceprint, and storing the test voiceprint for use as a comparison-related reference. In practice, the voiceprint test module 50 detects the cup bottoms 12 of 10 bad cups 10B and produces a bad voiceprint in accordance with the test voiceprint of the cup bottoms 12 of the 10 bad cups 10B.

In an embodiment of the present invention, performing comparison with a test voiceprint involves determining by the voiceprint test module 50 that the cup under test 10 is a good cup 10G when the difference between the test voiceprint of the cup bottom 12 of the cup under test 10 and the good voiceprint is not larger than ±3%, and determining by the voiceprint test module 50 that the cup under test 10 is a bad cup 10B when the difference between the test voiceprint of the cup bottom 12 of the cup under test 10 and the bad voiceprint is not larger than ±3%.

Referring to FIG. 1B, the voiceprint test module 50 further has a sound-collecting dish 51. The sound-collecting dish 51 hides a portion of the periphery of the voiceprint test module 50 but not a surface of the cup under test 10, wherein the surface of the cup under test 10 is to be tested by the voiceprint test module 50. Hence, the voiceprint test module 50 detects accurately the returning waves reflected off the cup bottom 12.

Referring to FIG. 1A and FIG. 1B, the rejection module 60 is fixed laterally to the conveyor belt 31 in the rejection area A2 and adapted to reject the bad cup 10B. The rejection module 60 has at least a rejection blower 61 for blowing the bad cup 10B off the conveyor belt 31 controllably.

The at least a rejection blower 61 is controlled by the voiceprint test module 50 or controlled by a controller, a processor, a computer, or a personal computer in blowing the bad cup 10B off the conveyor belt 31. If the at least a rejection blower 61 is controlled by a controller, a processor, a computer, or a personal computer, then the controller, the processor, the computer, or the personal computer will be connected to the voiceprint test module 50 to control the at least a rejection blower 61 in accordance with the result of the test performed with the voiceprint test module 50.

Referring to FIG. 1A and FIG. 1B, the collection module 70 is fixed in place within the collection area A3 and has a collection blower 71 and a collection pipe 72. With the collection blower 71, the good cup 10G conveyed by the conveyor belt 31 to the collection area A3 is blown off the conveyor belt 31 and admitted into the collection pipe 72 for collection.

In conclusion, as indicated by the above embodiments, the soundwave-based cup bottom detection test system 100 is characterized in that: the voiceprint test module 50 tests the cup bottom 12 of each said cup under test 10; the rejection module 60 blows the bad cup 10B off the conveyor belt 31, such that the bad cup 10B is blown off a box 40 through a rejection opening 42; the good cup 10G is collected by the collection module 70; hence, the soundwave-based cup bottom detection test system 100 ensures that every paper cup delivered will be of high quality and will be safe to use.

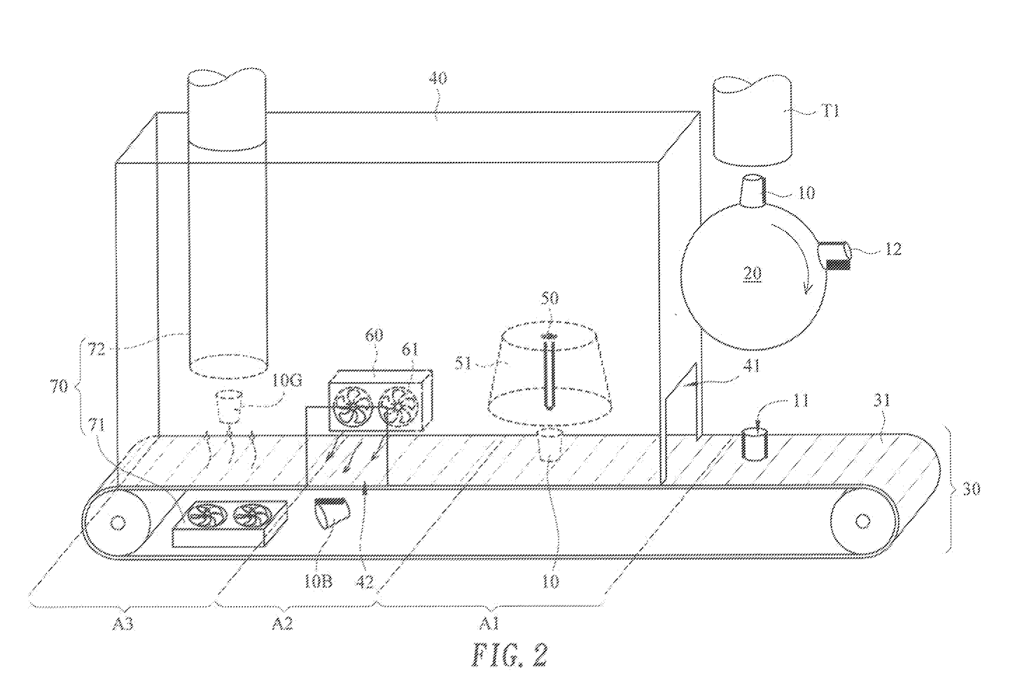

Referring to FIG. 2, the soundwave-based cup bottom detection test system 100 further has the box 40. The box 40 not only hides a portion of the conveying module 30 but also has a feed port 41 and a rejection opening 42. The test area A1, the rejection area A2 and the collection area A3 of the conveying module 30 are hidden by the box 40. Furthermore, the conveyor belt 31 of the conveying module 30 conveys the cup under test 10 from the feed port 41 into the box 40. The bad cup 10B is rejected and removed controllably from the box 40 through the rejection opening 42 by means of the rejection module 60.

Referring to FIG. 2, the box 40 fends off interference from external noise or air current to ensure accuracy in the testing of the cup bottoms 12 of the cup under tests 10 by the soundwave-based cup bottom detection test system 100.

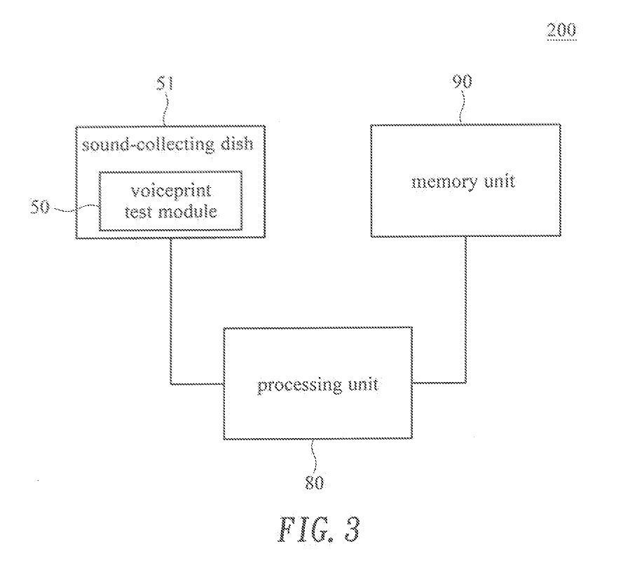

Referring to FIG. 3, there is shown a block diagram illustrative of a soundwave-based cup bottom detection test system 200 for use in sound wave detection of a cup bottom according to another embodiment of the present invention. The soundwave-based cup bottom detection test system 200 comprises a sound-collecting dish 51, a processing unit 80 and a memory unit 90.

Referring to FIG. 3, the sound-collecting dish 51 is dish-shaped and has therein a voiceprint test module 50. The technical features of the voiceprint test module 50 of the soundwave-based cup bottom detection test system 200 are identical to those of the voiceprint test module 50 of the soundwave-based cup bottom detection test system 100 and thus are not described again hereunder for the sake of brevity.

Referring to FIG. 3, the processing unit 80 controls the operation of the sound-collecting dish 51 and reads signals from the voiceprint test module 50 to carry out the step of producing a good voiceprint, the step of testing a cup under test, and the step of performing compliance identification.

Referring to FIG. 3, the memory unit 90 stores the good voiceprint and at least a test voiceprint in accordance with a command from the processing unit 80. The good voiceprint and the at least a test voiceprint stored in the memory unit 90 are accessible by the command from the processing unit 80 to enable the processing unit 80 to perform compliance identification on the cup under test 10 and thus determine whether the cup under test 10 is a good cup 10G.

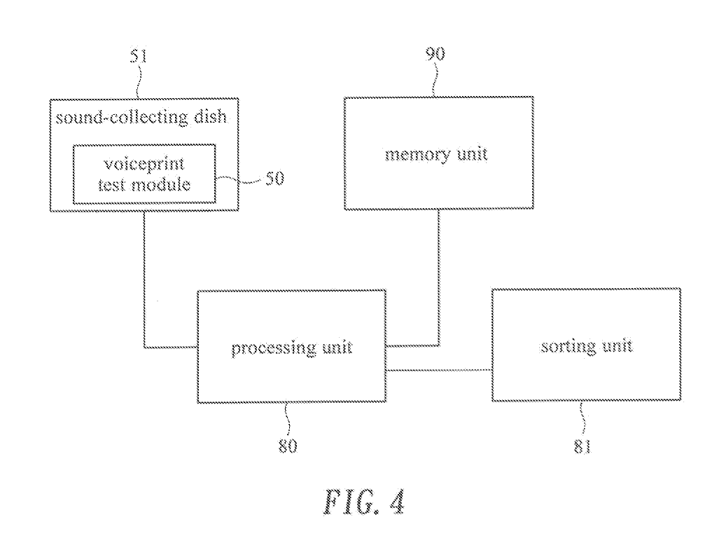

Referring to FIG. 4, the soundwave-based cup bottom detection test system 200 comprises a sorting unit 81 connected to the processing unit 80 and adapted to sort out good cups 10G from bad cups 10B in accordance with a result of compliance identification performed by the processing unit 80.

As indicated by the above embodiments, both the soundwave-based cup bottom detection test system 100 and the soundwave-based cup bottom detection test system 200 entail detecting the cup bottom 12 to obtain a test voiceprint with the voiceprint test module 50, comparing the test voiceprint and the good voiceprint or bad voiceprint, determining whether the cup under test 10 is a good cup 10G or bad cup 10B, rejecting, with the rejection module 60, the bad cup 10B determined by the voiceprint test module 50, conveying the good cup 10G to the collection area A3 with the conveyor belt 31, and collecting the good cups 10G with the collection module 70, thereby ensuring the high quality of the paper cups thus manufactured.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A soundwave-based cup bottom detection test system, comprising:
a feeding module for feeding consecutively at least a cup under test each having a cup mouth and a cup bottom;
a vacuum ball disposed rotatably at an outlet of the feeding module to suck the cup mouth and drive the cup under test rotationally;
a conveying module fixed to the vacuum ball from below and having a conveyor belt for conveying the cup under test having just fallen off the vacuum ball with the cup mouth facing upward, wherein the conveying module has a test area, a rejection area and a collection area arranged in sequence;
a voiceprint test module fixed to the conveyor belt in the test area from above and adapted to emit sound waves toward the cup bottom, receive returning wave reflected off the cup bottom, produce a test voiceprint, and determine whether the cup under test is a good cup or a bad cup;
a rejection module fixed laterally to the conveyor belt in the rejection area and adapted to reject the bad cup; and
a collection module disposed fixedly in the collection area and adapted to collect the good cup.

2. The test system of claim 1, wherein the voiceprint test module further has a sound-collecting dish.

3. The test system of claim 1, wherein the voiceprint test module compares the test voiceprint and a pre-stored good voiceprint or bad voiceprint and determines whether each said cup under test is the good cup or the bad cup.

4. The test system of claim 3, wherein the voiceprint test module not only receives the returning waves reflected off the cup bottoms of the good cups to therefore produce and pre-store the good voiceprint but also receives the returning wave reflected off the cup bottoms of the bad cups to therefore produce and pre-store the bad voiceprint.

5. The test system of claim 3, wherein the voiceprint test module determines that the cup under test is a good cup when the difference between the test voiceprint and the good voiceprint is not larger than ±3%.

6. The test system of claim 1, wherein a box covers the test area, the rejection area and the collection area of the conveyor belt from above and has a feed port and a rejection opening, and the conveyor belt conveys the cup under test from the feed port into the box, whereas the rejection module removes the bad cup from the box through the rejection opening.

7. The test system of claim 6, wherein the rejection module has at least a rejection blower for blowing the bad cup off the box through the rejection opening.

8. The test system of claim 1, wherein the collection module has a collection blower and a collection pipe, and the good cup which has entered the collection area is blown from the conveyor belt into the collection pipe by the collection blower.

9. A soundwave-based cup bottom detection test system, comprising:
a sound-collecting dish being dish-shaped and having therein a voiceprint test module;
a processing unit for controlling operation of the sound-collecting dish and reading signals of the voiceprint test module to produce a good voiceprint, and testing a cup under test to produce a test voiceprint and perform compliance identification; and
a memory unit for storing the good voiceprint and at least a said test voiceprint in accordance with a command from the processing unit.

10. The test system of claim 9, further comprising a sorting unit connected to the processing unit and adapted to sort out good cups from bad cups in accordance with a result of compliance identification performed by the processing unit.
